(19) United States
(12) Patent Application Publication
(10) Pub. No.: US 2006/0291241 A1
(43) Pub. Date: Dec. 28, 2006

(54) Light emitting diode illuminated display panel assembly

(75) Inventors: Richard Wojtowicz, Calgary (CA); Werner Reinhard Simbeck, Mill Bay (CA); Michael Iverson, Saanichton (CA); Aaron Lockwood, Victoria (CA); Donald C. Hargreaves, Sidney (CA)

Correspondence Address: QUARLES & BRADY STREICH LANG, LLP, ONE SOUTH CHURCH AVENUE, SUITE 1700, TUCSON, AZ, 85701-1621, US

(73) Assignee: Carmanah Technologies Corp.

(21) Appl. No.: 11/471,980

(22) Filed: Jun. 21, 2006

Related U.S. Application Data
(60) Provisional application No. 60/595,317, filed on Jun. 22, 2005.

(51) Int. Cl. G09F 13/18; F21V 7/04

(52) U.S. Cl. 362/604; 362/630; 40/546; 362/560

(57) ABSTRACT

An outdoor illuminated display panel assembly backlit by light emitting diodes (LEDs) edge-mounted on the panel assembly. A light pipe or light box distributes light from the LEDs evenly across the panel assembly. An energy management system adjusts battery charging rates and timing, turns LEDs on or off, and adjusts the luminous intensity of the LEDs to conserve battery power, if required. The display panel assembly may be self-supporting or a backmount system may be used to secure the illuminated display panel assembly to a post. Connections between the various parts of the assembly may be made so as to alleviate possible warping or breaking of the components. A solar panel may collect solar energy and a battery or super capacitor may store the collected solar energy so that the panel assembly may be illuminated irrespective of the light level incident on the solar panel.

### RELATED APPLICATIONS

This application claims priority from U.S. Provisional Patent Application Ser. No. 60/595,317 filed Jun. 22, 2005 which is hereby incorporated by reference.

This application is related to U.S. patent application Ser. No. ______, filed concurrently with this application and entitled “SOLAR POWERED LIGHT EMITTING DIODE ILLUMINATED DISPLAY PANEL ASSEMBLY” which is hereby incorporated by reference.

### FIELD OF THE INVENTION

This invention relates to outdoor sign panels, and in particular to an illuminated display panel assembly based on light-emitting diodes mounted within the assembly to backlight a roadway sign. A backmount mechanism to mount the display panel assembly on a pole or arm is also disclosed. A connection mechanism to allow for thermal expansion or contraction of the various components of the assembly, reducing warping or breaking any of the components, is also disclosed.

### BACKGROUND OF THE INVENTION

Prior art illuminated display panel assemblies, such as those incorporated into bus shelters or roadway signs to display advertising, street names or other signs, are typically light boxes having one or more fluorescent bulbs. Typically, these assemblies are powered from the electrical grid, which is only possible if the assembly is in close proximity to grid power. Even if grid power is accessible, making the connection often requires trenching or the installation of an additional power pole. As a result installing such an assembly can be both cost prohibitive and disruptive. In addition, after installation, these units consume power, adding to operating costs and potential indirect pollution. Further, the fluorescent tubes must be replaced periodically, adding to the maintenance costs.

In street name applications in particular, it is sometimes desirable to have a sign that mounts to the side of a support, such as a mast arm or pole and displays the name of the street toward oncoming traffic in one direction. In other cases it is desirable to have a street name sign that hangs below the support and displays the street name in both directions. Lighted street name signs are typically grid powered due to the size of the sign and the resultant large power consumption.

### SUMMARY OF THE INVENTION

The present invention alleviates the burdens inherent in the present state of the art in illuminated sign panels. It comprises an illuminated display panel assembly for mounting a translucent sheet on a frame, edge-lit for backlighting a poster, sign or other graphical element on the translucent sheet, and comprises at least one light source; at least one power source coupled to the light source; a light pipe supported on the frame, the light pipe being operative to accept light from the light source and to emit the light over a desired area of the assembly.

In another aspect, the invention comprises an illuminated display panel assembly with a first backbrace comprising at least a first slot coupled to the frame; a first mounting arrangement coupled to the first slot and operative to slide within the first slot; a second backbrace comprising at least a second slot coupled to the frame; a second mounting arrangement coupled to the second slot and operative to slide with the second slot; the first and second mounting arrangements being slidable to appropriate positions to mount the illuminated display panel assembly in a level position on a support.

In yet another aspect, the invention comprises an illuminated display panel assembly with at least one hole through the light pipe; at least one pin mountable in the hole and extending beyond the front and rear faces of the light pipe; a first slot extending along the frame; a second slot extending along the frame in opposed relation to the first slot; wherein the pin is slidable in the first slot and operative to mount the light pipe in the frame; and the second slot accommodates the translucent sheet; such that the light pipe and the translucent sheet are in non-rigid attachment to the frame.

In another aspect, the invention comprises at least one light emitting diode as the light source. The light emitting diode may be an edge-emitting light-emitting diode or a top-emitting light-emitting diode. The light source may be mounted in a hole in the light pipe, and the hole may be a through hole or a blind hole. Sealing means may be used to protect the light source from moisture or other environmental contaminants. These sealing means may comprise a gasket in the hole, about the light source.

In a further aspect, the invention may comprise a reflective surface mounted on the light pipe in opposed relation to the light source. In a further aspect, the invention may comprise a reflective coating on a surface of the light pipe, such that the coating reflects light back into the light pipe so that it may be emitted in a desired direction. In yet a further aspect, a reflective coating may be added about at least a portion of the periphery of the light pipe.

A polarizing film mounted on the light pipe may be used to reduce glare or interference to one side of the light pipe.

In another aspect, the invention further comprises a energy storage unit electrically connectable to the light source; and at least one solar panel electrically connectable to the energy storage unit. The light source may be electrically connected to the energy storage unit through at least one printed circuit board or through least one light emitting diode harness.

In yet another aspect, the invention comprises a solar powered illuminated display panel assembly for mounting a translucent sheet on a central panel comprising at least one solar panel; a energy storage unit electrically connectable to the solar panel; at least one light source electrically connectable to the energy storage unit to receive power from the energy storage unit; the light source being mountable in at least one hole in the central panel. In a further aspect, the light source may be an edge-emitting light emitting diode. Sealing means, such as a gasket about the periphery of the light source, may be used to protect the light source from moisture or other contaminants.

In a further aspect, the invention comprises a reflective coating mountable on the central panel opposite the translucent sheet.

In yet a further aspect, the invention comprises an energy management system electrically connectable to the solar panel and capable of controlling energy received from the solar panel. The energy management system may be further electrically connectable to the energy storage unit and capable of controlling power received from the energy storage unit. The energy management system may also be operatively connectable to a detector which monitors the illumination emitted by the light source and is capable of controlling the illumination

In another aspect, the invention comprises a solar powered illuminated display panel assembly for mounting a translucent sheet on a central panel comprising at least one solar panel; a energy storage unit electrically connectable to the solar panel; at least one light source electrically connectable to the energy storage unit to receive power from the energy storage unit; the light source being mountable along an edge of the central panel and capable of emitting illumination from its top surface inward of the edge.

In yet another aspect, the invention comprises a solar powered illuminated display panel assembly for mounting a translucent sheet on a central panel comprising at least one solar panel; a energy storage unit electrically connectable to the solar panel; at least one light source electrically connectable to the energy storage unit to receive power from the energy storage unit; sealing means to protect the light source from moisture; an energy management system electrically connectable to the solar panel and capable of controlling energy received from the solar panel, the energy management system being further electrically connectable to the energy storage unit and capable of controlling power received from the energy storage unit; a detector to monitor the illumination emitted by the light source, wherein the energy management system is operatively connectable to the detector and is capable of controlling the illumination; and a chassis enclosing the sign panel.

### BRIEF DESCRIPTION OF THE DRAWINGS

The invention will be described by reference to the detailed description of the preferred embodiment and to the drawings thereof in which:

FIG. 1 is a perspective view of an assembled illuminated display panel assembly according to an embodiment of the present invention.

FIG. 2 is an exploded perspective view of the illuminated display panel assembly of FIG. 1, disassembled into its constituent sub-assembly and parts.

FIG. 2A is an enlarged view of a section of the illuminated display panel assembly of FIG. 2, showing a light pipe with assembled LEDs, battery, energy management system, and various wiring electrically connecting these elements.

FIG. 3 is an enlarged view of a section of the illuminated display panel assembly of FIG. 2, showing a light pipe, an LED, an LED gasket, and an LED wiring harness.

FIG. 4 is an enlarged view of an LED gasket, an LED wiring harness, and an LED.

FIG. 5 is an enlarged exploded perspective view of a mounting arrangement for an LED within a light pipe.

FIG. 6 is a front perspective view of an illuminated display panel assembly holding a street name sign according to the invention, including backmount hardware.

FIG. 7 is a back perspective view of an illuminated display panel assembly holding a street name sign according to the invention, including backmount hardware.

FIG. 8 is an enlarged view of the backmount hardware of FIG. 7.

FIG. 9 is enlarged view of a mounting arrangement of a light pipe within an illuminated display panel assembly holding a street name sign.

FIG. 10 is an end view of two embodiments of an illuminated display panel assembly holding a street name sign, showing the light ray paths for each embodiment.

FIG. 11 is an alternative embodiment of an LED mounting arrangement within an illuminated display panel assembly holding a street name sign.

### DETAILED DESCRIPTION OF THE PREFERRED EMBODIMENT

The illuminated display panel assembly is described in more detail in the following, with reference made to the drawings contained herein.

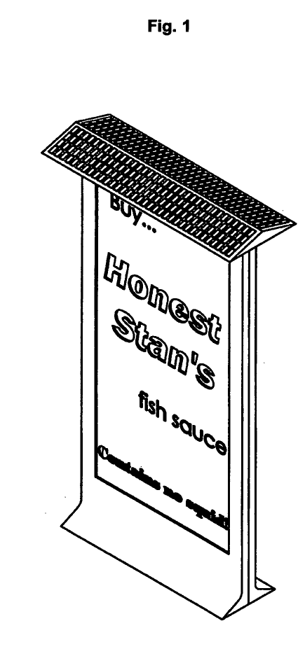

FIG. 1 shows an embodiment of the illuminated display panel assembly, housing a sample advertising sign.

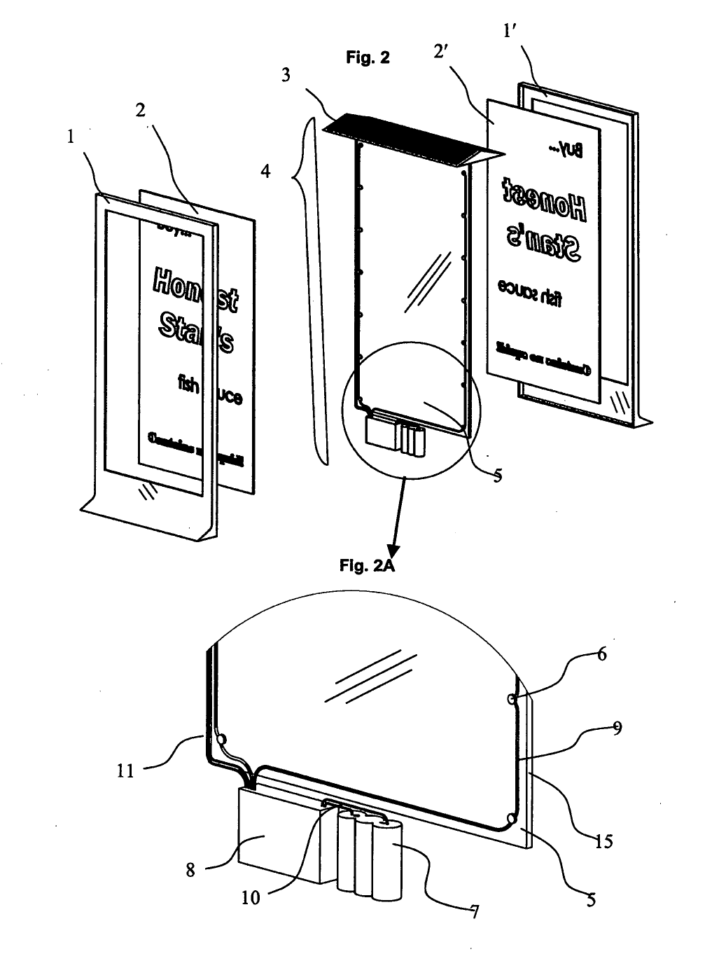

In FIG. 2, the illuminated display panel assembly is shown partially disassembled. Housing the internal components is a chassis, which may be made up of two sheet metal frame halves 1,1′. The chassis frame halves 1,1′ give mechanical strength to the display panel assembly, and allow the assembly to tolerate the loadings the assembly may experience when installed in an urban environment, including wind forces and minor impacts with pedestrians, bicycles, and snow removal equipment. The chassis frame halves 1,1′ also serve as the mechanical structure to which the other components of the assembly are attached. In addition, the chassis frame halves 1,1′ protect the internal components from damage due to mechanical impact and weather-related causes.

The advertisement, signage or other artwork is printed on one or more translucent or transparent graphics sheets 2,2′ which form faceplates for the sign. Light passes from a light pipe 5 through the inward-facing surface of each sheet and exits through the outward-facing surface, illuminating and increasing the conspicuousness of the artwork printed on the graphics sheets 2,2′. The artwork may comprise information such as a street name, advertising etc. The artwork may be formed of transparent and/or translucent areas in combination with opaque areas and/or areas that transmit different colours of light. There may be graphics sheets on one side or two sides of the light pipe respectively, depending on the geometry of the chassis and the intended installation geometry (e.g. a wall-mounted illuminated display panel assembly may only include one artwork transparency). In the case of a single sided sign, a substantially reflective material may be placed on the back of the light pipe, opposite to the single graphics sheet, to maximize the amount of light incident on the single graphics sheet 2.

Light to illuminate the graphics sheets is generated by the light pipe engine subassembly 4, the lower portion of which is depicted in greater detail in FIG. 2A. Incident sunlight causes the solar panel array 3 to generate electrical energy, which is carried to the energy management system 8 via the solar panel harness 11. This electrical energy is conveyed to the battery 7 by the battery harness 10. The rate at which this energy is supplied to the battery 7 is calculated and metered by the energy management system 8 such that battery life is maximized and overall system performance optimized. When the energy management system 8 senses that the output voltage of the solar panel array has decreased below a certain threshold value corresponding to the ambient light level at which panel illumination is desired, the energy management system 8 provides power to the LED harness 9. In another embodiment, a separate illumination detector is used to sense the ambient light level. The LED harness 9 supplies electrical energy to the LEDs 6. In another embodiment, elements of the LED harness 9 are replaced by one or more Printed Circuit Boards (PCBs) onto which the LEDs 6 are soldered, as described in more detail below. Mounting the LEDs 6 to PCBs in this manner more effectively conducts heat away from the LEDs 6, improving their reliability and performance.

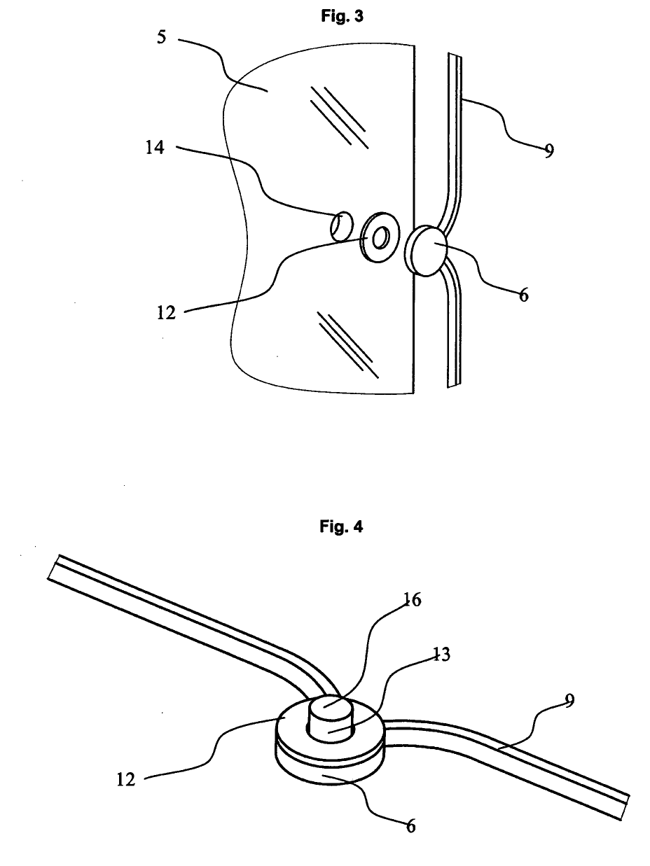

FIG. 3 is a detailed view of an LED 6, the light pipe 5, and an LED gasket 12. The LED gasket 12 is installed between the light pipe 5 and the LED 6, prior to the installation of the LED 6, which is assembled into a blind hole 14 in the light pipe 5. The LED gasket is substantially reflective on the side that contacts the light pipe. In another embodiment, the hole 14 into which the LED 6 is inserted may extend through the light pipe 5; a sticker or plug having a substantially reflective surface facing the LED 6 is used to cover the hole 14 opposite the LED 6. The LED 6 used in the assembly has the characteristic that the majority of its luminous output is directed radially through LED surface 13 in FIG. 4. The light from LED surface 13 enters the light pipe 5 through the internal surface of LED hole 14. The LED gasket 12 protects surfaces 13 and 14 from debris and moisture, both of which have a deleterious effect on light transmission. The light pipe 5 is made from a light-conductive plastic material. As light is transmitted from the LED hole surfaces 14 through the light pipe 5, a portion of it escapes from the light pipe 5, illuminating the artwork on graphics sheets 2,2′ (shown only in FIG. 2).

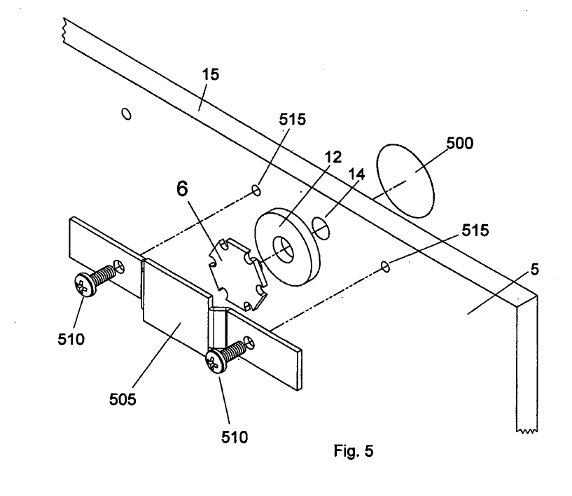

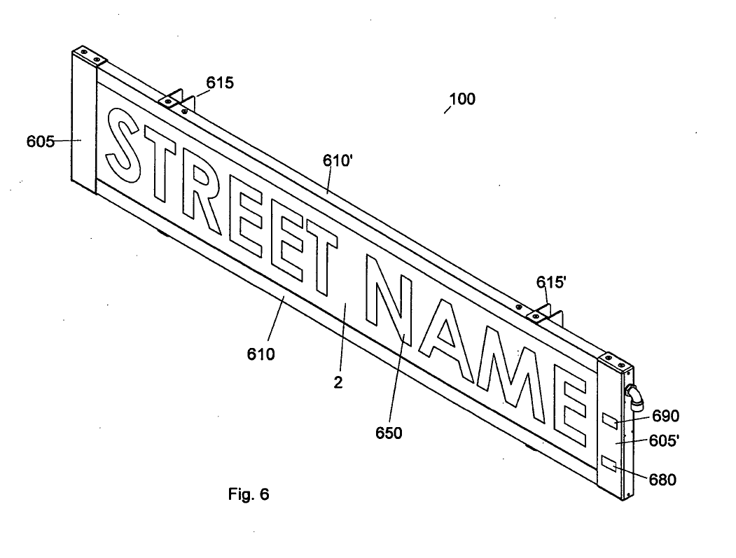

A modified mounting arrangement for the LED 6 is shown in FIG. 5. An LED mounting bracket 505 and LED mounting bracket screws 510 secure the LED 6 and gasket 12 into the light pipe 5. An LED reflector 500 is mounted to the opposite side of the light pipe 5 via an adhesive to both reflect light that would otherwise shine directly out of the light pipe 5 back into the light pipe 5 and to seal the LED hole 14. LED mounting bracket holes 515 accept LED mounting bracket screws 510 and hold the assembly in place. The LED reflector 500 may be a reflective label material with appropriate adhesive applied (in effect, a reflective sticker).

The narrow edges 15 of light pipe 5 may be covered with a reflective coating or covering to prevent light leakage from the light pipe 5.

In another embodiment, the LEDs 6 may be assembled onto one or more of the narrow edges 15 of the light pipe 5, or into blind holes on said narrow edges. The style of LED typically selected for use in this embodiment emits the majority of its luminous output through top surface 16 (FIG. 4), so that light is most efficiently transmitted toward the center of the light pipe 5.

A surface treatment may be administered to the front and rear surfaces of the light pipe 5 in such a way as to result in an even distribution of escaped light across these surfaces of light pipe 5, resulting in uniformly illuminated artwork transparencies. Alternatively, or in addition to treatment of the external light pipe surfaces, a material having special light-scattering properties may be used to achieve even artwork transparency illumination. A reflective tape or film is typically applied around the outer perimeter of the light pipe 5 to minimize light losses through that surface.

FIG. 6 depicts another embodiment of an illuminated display panel assembly of the present invention, namely a street name sign 100. Street name sign 100 may incorporate a backmount arrangement, which is particularly suited for mounting street name sign 100 to a support, such as a mast arm, over a street. The frame of the display panel assembly comprises endcaps 605, 605′ which engage frame extrusions 610, 610′ and may house electronics such as energy management system 8 (FIG. 2A) to control the operation of the sign. The energy management system 8 may receive energy from solar panel array 3 (FIG. 2) or grid power. Frame extrusions 610, 610′ support graphic sheets 2, 2′ and the internal sign components as described below. Brackbraces 615, 615′ engage the frame extrusions 610, 610′.

The street name sign 100 may comprise a motion detector 680 and/or an illumination detector 690. These components are particularly useful if the street name sign 100 is solar-powered. The motion detector 680 and illumination detector 690 are coupled to the energy management system 8 (not shown). The motion detector 680 may detect the motion of oncoming vehicles or pedestrians. The illumination detector 690 may detect light from oncoming vehicles. Since the illumination detector 690 is directed toward oncoming traffic and a solar panel array 3 (not shown) is typically directed skyward, the energy management system 8 can differentiate between sunlight and oncoming vehicle headlights. That is, when an illumination level greater than a pre-determined threshold level is detected by only the illumination sensor 690 and not the solar panel array 3, the LEDs 6 (not shown) may be turned on. The energy management system 8 may thus only illuminate LEDs 6 when oncoming vehicles are detected and only at night. Alternatively, if the street name sign 100 is not solar powered or if another reference illumination level is desirable, a second illumination sensor may be provided and directed in a direction other than into oncoming traffic in order that ambient light and oncoming vehicle light may be differentiated.

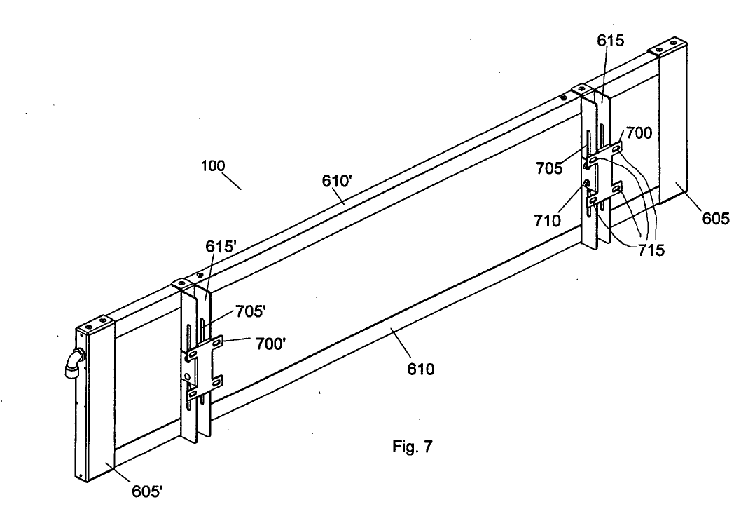

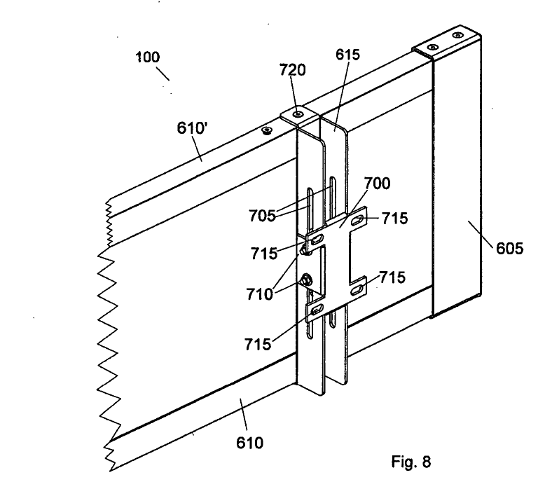

FIG. 7 depicts a back view of the street name sign 100 showing the backmount arrangement of the invention. Backbraces 615, 615′ comprise backbrace slider slots 705, 705′. Backbrace sliders 700, 700′ are mounted within the backbrace slider slots 705, 705′ and may be slid up and down within the backbrace slider slots. This allows the street name sign 100 to be mounted to a support, such as a mast arm, over a street in a level orientation, even if the mast arm is not level, by sliding the backbrace sliders 700, 700′ vertically up or down to compensate for the slope of the mast arm.

FIG. 8 depicts a more detailed view of the backmount arrangement. Backbrace slider 700 is secured to the backbrace slider slots 705 by a backbrace nut/screw arrangement 710. This arrangement is tightened once the desired position of the backbrace slider 700 is determined. Backbrace slider mounting locations 715 engage an appropriate bracket or other arrangement to secure the street name sign 100 to the mast arm. Backbrace attachment screws 720 secure the backbrace 615 to the street name sign 100.

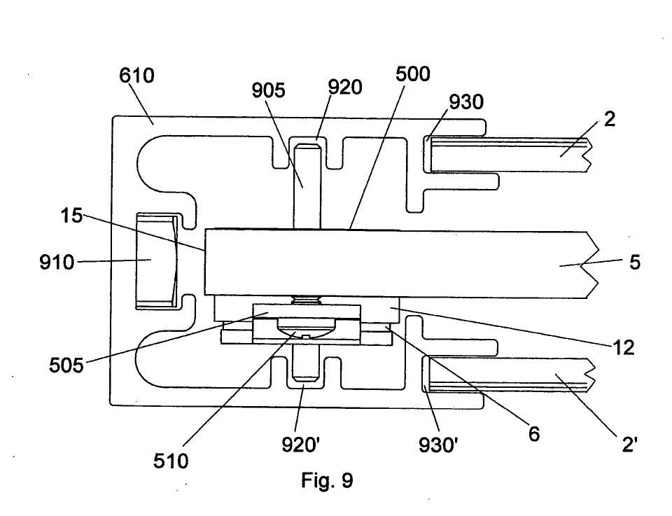

FIG. 9 depicts a mounting arrangement for a light/LED assembly within a frame of the street name sign 100. Light pipe support pins 905 are inserted through the light pipe 5 at several locations along the light pipe 5. The light pipe support pins 905 slide into slots 920, 920′ within the frame extrusion 610. Graphic sheets 2, 2′ also slide into slots 930, 930′ in the frame extrusion 610. The fact that the light pipe 5 and graphic sheets 2, 2′ are not rigidly fastened to the frame extrusion 610 allows for differing coefficients of expansion for the typically plastic light pipe 5 and graphic sheet 2,2′ material and the typically metal frame extrusion 610. Therefore, extremes of temperature are less likely to cause warpage or breakage of the different elements of the sign. Backbrace attachment screw nuts 910 are captive within the frame extrusion 610 and are adapted to engage the backbrace attachment screws 720.

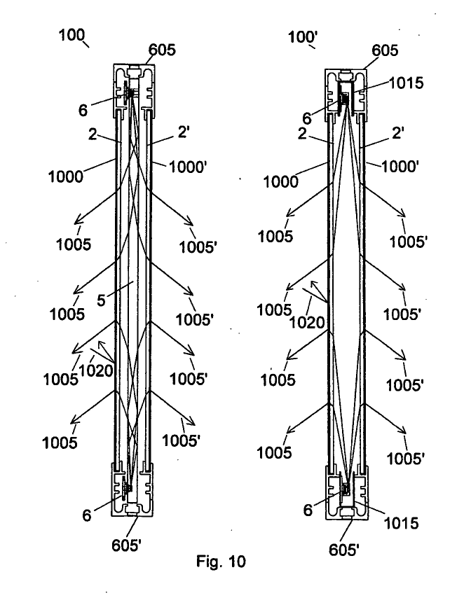

FIG. 10 depicts end views of the street name sign 100 and an alternative street name sign 100′ without a light pipe. In both embodiments, light rays 1005, 1005′ are emitted from the LEDs 6. In street name sign 100, the light rays transition through the light pipe 5, out of the sign through graphic sheet 2, 2′ and may be directed downward toward a viewer by polarizing or collimating film 1000, 1000′. Film 1000, 1000′ may also reflect ambient light rays 1020 so that a shadow of the image on one side of the sign is not cast on the other side when (for example) the sun shines directly on one side of the sign. This may also minimize reflection of the sun into an observer's eyes. Alternatively, film 1000 may scatter ambient light rays within the street name sign 100 such that no shadow is cast. Alternative street name sign 100′ does not comprise light pipe 5 and therefore, reflective surfaces 1015 within endcaps 605, 605′ direct the light into the center of the street name sign 100′, where it is emitted. In both embodiments, street name sign 100 or 100′ may be made in a uni-directional configuration if one side of the sign is coated or covered with a reflective material. In this configuration, graphic sheet 2′ and polarizing film 1000′ are not present. Also, light rays 1005′ will transition out of the apparatus in the same direction as light rays 1005.

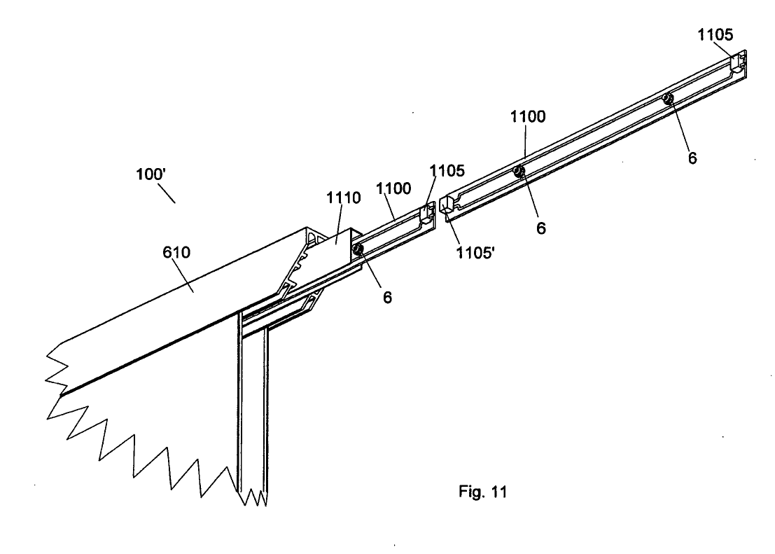

FIG. 11 depicts an alternative arrangement for mounting the LEDs 6 within the alternative street name sign 100′. In this arrangement, the LEDs 6 are mounted to printed circuit boards (PCBs) 1100. The PCBs are slid within LED reflector/PCB support channel 1110 which in turn slides into frame extrusion 610. Various PCBs 1100 may be coupled together using connectors 1105, 1105′. This arrangement allows for easy replacement of the LEDs 6 should one or more of them burn out. LEDs 6 typically have much longer life than traditional technologies, but may eventually need to be replaced. The arrangement shown in FIG. 11 may also be used with other light sources other than LEDs 6.

It will be appreciated by those skilled in the art that the preferred and alternative embodiments have been described in some detail but that certain modifications may be practiced without departing from the principles of the invention. For example solar panel array 3 and/or energy management system 8 may be incorporated into the street name sign 100.

What is claimed is:

1. An illuminated display panel assembly for mounting a translucent sheet on a frame, comprising;
at least one light source;
at least one power source coupled to said light source;
a light pipe supported on said frame, said light pipe being operative to accept light from said light source and to emit said light over a desired area of said assembly;
a first backbrace comprising at least a first slot coupled to said frame;
a first mounting arrangement coupled to said first slot and operative to slide within said first slot;
a second backbrace comprising at least a second slot coupled to said frame;
a second mounting arrangement coupled to said second slot and operative to slide with said second slot;
said first and second mounting arrangements being slidable to appropriate positions to mount said illuminated display panel assembly in a level position on a support.

2. An illuminated display panel assembly for mounting a translucent sheet on a frame comprising;
at least one light source;
a power source electrically coupled to said light source;
a light pipe supported on said frame, said light pipe being operative to accept light from said light source and emit said light over a desired area of said assembly;
at least one hole through said light pipe
at least one pin mountable in said at least one hole and extending beyond the front and rear faces of said light pipe;
a first slot extending along said frame;
a second slot extending along said frame;
wherein said pin is slidable in said first slot and to mount said light pipe in said frame; and
said second slot accommodates said translucent sheet; such that said light pipe and said translucent sheet are in non-rigid attachment to said frame.

3. The illuminated display panel assembly of claim 1 or claim 2 wherein said translucent sheet is operative to allow the transmission of at least a portion of said light in order to display information.

4. The illuminated display panel assembly of claim 1 or claim 2, wherein said light source is at least one light emitting diode.

5. The illuminated display panel assembly of claim 4, wherein said light emitting diode is an edge-emitting light-emitting diode.

6. The illuminated display panel assembly of claim 4, wherein said light emitting diode is a top-emitting light-emitting diode.

7. The illuminated display panel assembly of claim 1 or claim 2, further comprising a reflective surface mounted on said light pipe in opposed relation to said light source.

8. The illuminated display panel assembly of claim 1 or claim 2 wherein said light source is mounted in a hole in said light pipe.

9. The illuminated display panel assembly of claim 8 wherein said hole is a blind hole.

10. The illuminated display panel assembly of claim 1 or claim 2, further comprising sealing means to protect said at least one light source from moisture.

11. The illuminated display panel assembly of claim 10 wherein said sealing means comprises a gasket about the periphery of said light source.

12. The illuminated display panel assembly of claim 1 or claim 2, further comprising:
a energy storage unit electrically connectable to said light source; and
at least one solar panel electrically connectable to said energy storage unit.

13. The illuminated display panel assembly of claim 12 wherein said at least one light source is electrically connectable to said energy storage unit through at least one printed circuit board.

14. The illuminated display panel assembly of claim 12 wherein said at least one light source is electrically connectable to said energy storage unit though at least one light emitting diode harness.

15. The illuminated display panel assembly of claim 1 or claim 2, further comprising a polarizing film mounted on said light pipe.

16. The illuminated display panel assembly of claim 1 or claim 2, further comprising a reflective coating on a surface of said light pipe, said reflective coating being positioned to reflect light back into said light pipe.

17. The illuminated display panel assembly of claim 1 or claim 2, further comprising a reflective coating about at least a portion of the periphery of said light pipe.

18. The illuminated display panel assembly of claim 1 or claim 2, further comprising an energy management system electrically connectable to said light source and capable of controlling energy received from said power source.

19. The illuminated display panel assembly of claim 18, further comprising a detector to monitor the illumination emitted by an external source of light, wherein said energy management system is operatively connectable to said detector and is capable of controlling said illumination based on the brightness of said external source of light.

20. The illuminated display panel assembly of claim 1 or claim 2, further comprising:
a second translucent sheet;
wherein said translucent sheet is mounted in said frame facing a first side of said light pipe and said second translucent sheet is mounted in said frame on the opposing side of said light pipe; said light pipe operative to emit light rays through both said translucent sheet and said second translucent sheet.
